(19) United States
(12) Patent Application Publication
(10) Pub. No.: US 2017/0047000 A1
(43) Pub. Date: Feb. 16, 2017

(54) DISPLAY DEVICE AND DRIVING METHOD THEREOF

(71) Applicant: SAMSUNG DISPLAY CO., LTD., Yongin-si (KR)

(72) Inventors: Hong Soo KIM, Yongin-si (KR); Se Hyuk PARK, Yongin-si (KR); Seong Heon CHO, Yongin-si (KR)

(21) Appl. No.: 15/156,454

(22) Filed: May 17, 2016

(30) Foreign Application Priority Data
Aug. 13, 2015 (KR) 10-2015-0114843

(51) Int. Cl. G09G 3/20

(52) U.S. Cl. CPC G09G 3/2092; G09G 3/2003

(57) ABSTRACT

A display device includes a scan driver to supply a scan signal to scan lines, a data converter to receive a first data corresponding to a first wavelength range and to generate a second data corresponding to a second wavelength range by using the first data, a data driver to generate a data signal to be supplied to data lines by using the first data or the second data, and pixels in areas defined by the scan and data lines to emit light in accordance with the data signal.

### CROSS-REFERENCE TO RELATED APPLICATION

Korean Patent Application No. 10-2015-0114843, filed on Aug. 13, 2015, in the Korean Intellectual Property Office, and entitled: “Display Device and Driving Method Thereof,” is incorporated by reference herein in its entirety.

### BACKGROUND

1. Field

An exemplary embodiment relates to a display device and a driving method thereof, and more particularly, to a display device capable of changing data to a wavelength range visible to pet animals and a driving method thereof.

2. Description of the Related Art

As single households increase, a pet animal market has been growing. Pet animals are left alone when family members go to work or go to school. In addition, it is often difficult to accompany pet animals even when going to suburbs to enjoy a leisure life on weekends.

When left alone at home, pet animals experience emotional anxiety and stress, and show some abnormal behavior, e.g., howling and the like, if they are sensitive. Accordingly, in order to relieve anxiety of pet animals, the number of households keeping their TVs turned on for the pat animals has been increasing. For example, more than 10,000 households have been watching DOG TV before one year has passed since it started broadcasting.

### SUMMARY

Embodiments have been made to provide a display device capable of changing data to a wavelength range visible to pet animals and a driving method thereof.

A display device may include a scan driver to supply a scan signal to scan lines, a data converter to receive a first data corresponding to a first wavelength range and to generate a second data corresponding to a second wavelength range by using the first data, a data driver to generate a data signal to be supplied to data lines by using the first data or the second data, and pixels in areas defined by the scan and data lines to emit light in accordance with the data signal.

The first wavelength range may be a wavelength range visible to human.

The second wavelength range may be a wavelength range visible to animals.

The second wavelength range may be a wavelength range visible to dogs.

The display device may include a timing controller configured to receive the second and first data and to supply the first data or the second data to the data driver.

The display device may include a timing controller for supplying the first data to the data converter or the data driver.

The data converter may include: a first converter for generating third data including the first wavelength range information by using the first data including red, green, and blue data; a wavelength converter for generating fourth data including only information about the second wavelength range by using the third data; and a second converter for generating the second data including red, green, and blue data by using the fourth data.

The display device may further include a storage unit for providing at least one minimum value and at least one maximum value corresponding to the second wavelength range to the wavelength converter.

The third data and the fourth data may have information about hue (H), saturation, and intensity.

A driving method of the display device according to an exemplary embodiment may include generating second data corresponding to a second wavelength range by using first data corresponding to a first wavelength range; and realizing an image by using the first data or the second data.

The first wavelength range may be a wavelength range visible to human.

The second wavelength range may be a wavelength range visible to animals.

The second wavelength range is a wavelength range visible to dogs.

Generating the second data includes: generating third data including information about hue (H), saturation, and intensity by using the first data including red, green, and blue data; generating fourth data by extracting the second wavelength range from the third data; and generating the second data including red, green, and blue data by using the fourth data.

### BRIEF DESCRIPTION OF THE DRAWINGS

Features will become apparent to those of ordinary skill in the art by describing in detail exemplary embodiments with reference to the attached drawings, in which:

FIG. 1 illustrates a schematic view of a display device according to an exemplary embodiment.

FIG. 2 illustrates an exemplary embodiment of a data converter illustrated in FIG. 1.

FIG. 3 illustrates color information of third data generated from the first converter illustrated in FIG. 2.

FIG. 4 illustrates an exemplary embodiment of an operating process of a wavelength converter illustrated in FIG. 2.

FIG. 5 illustrates a schematic view of images displayed according to the exemplary embodiment.

FIG. 6 illustrates a schematic view of a display device according to another exemplary embodiment.

FIG. 7 illustrates Equation 1.

FIG. 8 illustrates Equation 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of elements and regions may be exaggerated for clarity of illustration. It will also be understood that when an element is referred to as being “on” another element, it can be directly on the other element, or intervening elements may also be present. Further, it will be understood that when an element is referred as being “coupled” to another element or “between” elements, the element may be “directly coupled” to the other element or “directly between” the other elements, or intervening elements may be present, e.g., to be “electrically coupled” to the other element through a third element. In addition, it should be noted that the same components in one drawing are marked with the same reference numerals and symbols even though they are illustrated in another drawing.

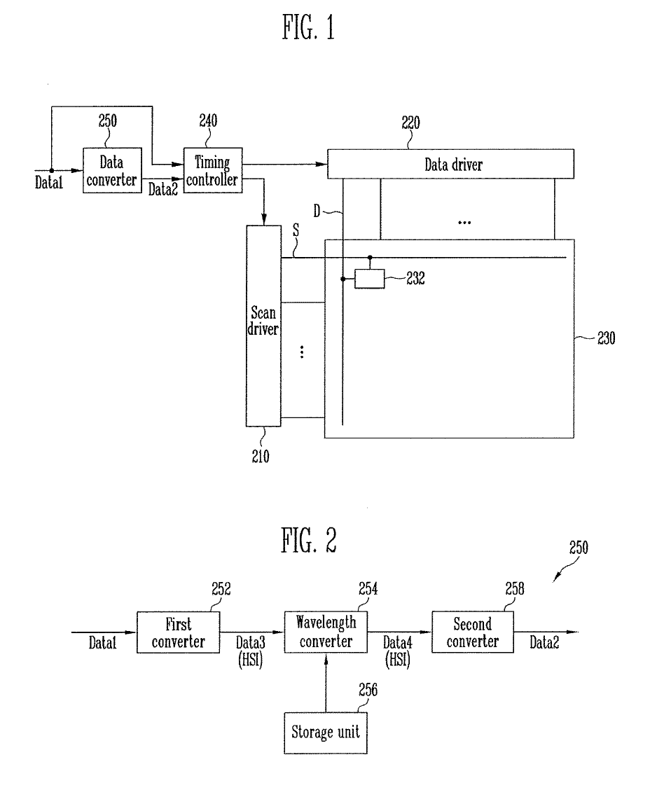

FIG. 1 is a schematic view of a display device according to an exemplary embodiment.

Referring to FIG. 1, a display device according to the current exemplary embodiment may include a scan driver 210, a data driver 220, a pixel area 230, a timing controller 240, and a data converter 250.

The pixel area 230 displays an image that corresponds to a data signal supplied from the data driver 220. The pixel area 230 includes pixels 232 that include, e.g., liquid crystals (LCs) or an organic light emitting diode (OLED). When the pixels 232 include the LCs, a backlight unit for supplying light to the pixel area 230 may be additionally included.

The pixels 232 are positioned in areas that are divided by scan lines S and data lines D. The pixels 232 are horizontally selected on a line-by-line basis in accordance with the scan signal supplied to the scan lines S, and store the data signal from the data lines D that are connected to the pixels 232. Then, the pixels 232 emit light with a predetermined luminance in accordance with the data signal, thereby displaying an image.

The scan driver 210 supplies the scan signal to the scan lines S in accordance with control of the timing controller 240. For example, the scan driver 210 may sequentially supply the scan signal to the scan lines S. When the scan signal is sequentially supplied to the scan lines S, the pixels 232 are horizontally selected on a line-by-line basis.

The data driver 220 generates the data signal in accordance with first data (Data1) or second data (Data2) that is supplied from the timing controller 240, and supplies the generated data signal to the data lines D such that the data signal is synchronized with the scan signal. The data signal supplied to the data lines D is supplied to the pixels 232 that are selected by the scan signal.

The timing controller 240 receives the first data (Data1) from the outside, and the second data (Data2) from the data converter 250. After receiving the first data (Data1) and the second data (Data2), the timing controller 240 supplies the first data (Data1) or the second data (Data2) to the data driver 220.

The data converter 250 receives the first data (Data1) from the outside, e.g., from an external source, and generates the second data (Data2) using the supplied first data (Data1). The second data (Data2) generated from the data converter 250 is supplied to the timing controller 240.

The first data (Data1) includes red, green, and blue data corresponding to a first wavelength range. The second data (Data2) includes red, green, and blue data corresponding to a second wavelength range.

In this case, the first wavelength range represents a wavelength range visible to humans, while the second wavelength range represents a wavelength range visible to pet animals. For example, the second wavelength range may be set to a wavelength range visible to dogs.

The timing controller 240 supplies the first data (Data1) or the second data (Data2) to the data driver 220. In this case, when the first data (Data1) is supplied to the data driver 220, an image of the wavelength range visible to humans is displayed on the pixel area 230. When the second data (Data2) is supplied to the data driver 220, an image of the wavelength range visible to pet animals is displayed on the pixel area 230. That is, the display device may display the image of the wavelength range visible to pet animals, and as a result, pet animals may view the image with interest.

FIG. 2 illustrates an exemplary embodiment of the data converter 250 in FIG. 1. Referring to FIG. 2, the data converter 250 according to the current exemplary embodiment may include a first converter 252, a wavelength converter 254, a second converter 258, and a storage unit 256.

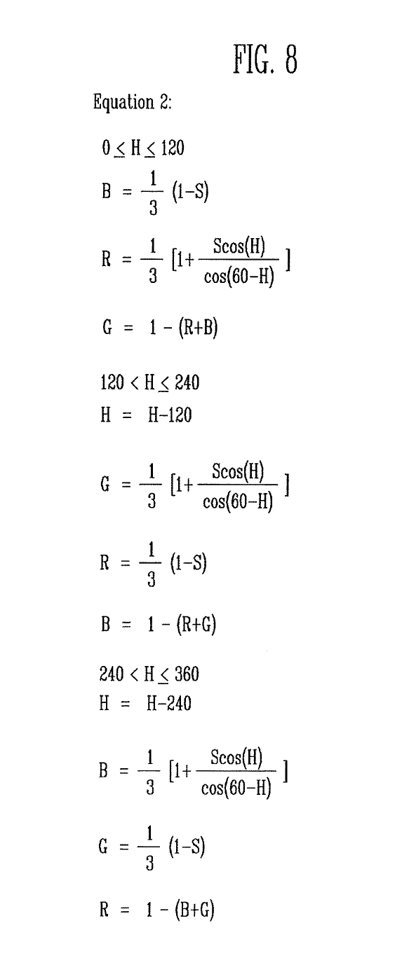

The first converter 252 generates third data (Data3) including information about hue (H), saturation, and intensity (or value) by using the first data (Data1) including red, green, and blue data. For example, the first converter 252 may generate the third data (Data3) using Equation 1 illustrated in FIG. 7.

In Equation 1, H represents hue of the third data (Data3), S represents saturation of the third data (Data3), and I represents intensity of the third data (Data3). R, G, and B respectively represent red data (R), green data (G), and blue data (B) that are included in the first data (Data1). In addition, the equation for generating the third data (Data3) from the first data (Data1) is not limited to Equation 1. For example, the first converter 252 may use various currently known methods for generating information about hue, saturation, and intensity by using red, green, and blue data R, G and B. The third data (Data3) generated from the first converter 252 includes, as shown in FIG. 3, color information corresponding to the wavelength range.

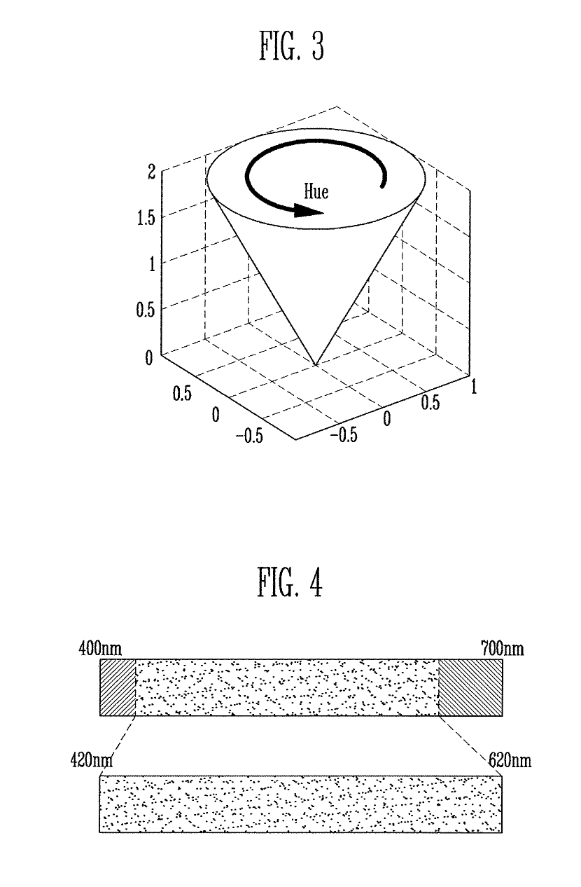

The wavelength converter 254 generates fourth data (Data4) with a limited wavelength range in accordance with information about at least one minimum value and at least one maximum value stored in the storage unit 256. For example, the third data (Data3) generated using the first data (Data1) has, as shown in FIG. 4, the first wavelength range of about 400 nm to 700 nm that is visible to human. The wavelength converter 254 extracts the second wavelength range visible to pet animals from the first wavelength range by using the minimum and maximum values stored in the storage unit 256, and generates the fourth data (Data4) corresponding to the second wavelength range. For example, the wavelength converter 254 may generate the fourth data (Data4) to include a wavelength range of about 420 nm to 620 nm, which is visible to dogs.

The storage unit 256 may include information about at least one minimum value and at least one maximum value that correspond to the second wavelength range. A plurality of minimum and maximum values may be stored in the storage unit 256 in accordance with various animals (dogs, cats, etc.), and in this case, the second wavelength range of fourth data (Data4) may be set to an optimal value in accordance with the pet animal.

The second converter 258 generates the second data (Data2) including red, green, and blue data by using the fourth data (Data4) including information about hue, saturation, and intensity. For example, the second converter 258 may generate the second data (Data2) using Equation 2 in FIG. 8.

In Equation 2, H represents hue of the fourth data (Data4), S is saturation of the fourth data (Data4), and I is intensity of the fourth data (Data4). In Equation 2, R, G, and B represent red data (R), green data (G), and blue data (B) of the second data (Data2). In addition, the equation for generating the fourth data (Data4) from the second data (Data2) is not limited to Equation 2. For example, the second converter 258 may use various currently known methods for generating red, green, and blue data R, G and B by using information about hue, saturation, and intensity. The second data (Data2) generated from the second converter 258 is supplied to the timing controller 240.

After receiving the first data (Data1) and the second data (Data2), the timing controller 240 supplies the first data (Data1) or the second data (Data2) to the data driver 220 in accordance with control from the outside. An image of the first wavelength range visible to humans is displayed on the pixel area 230 when the first data (Data1) is supplied to the data driver 220, and an image of the second wavelength range visible to pet animals is displayed on the pixel area 230 when the second data (Data2) is supplied thereto.

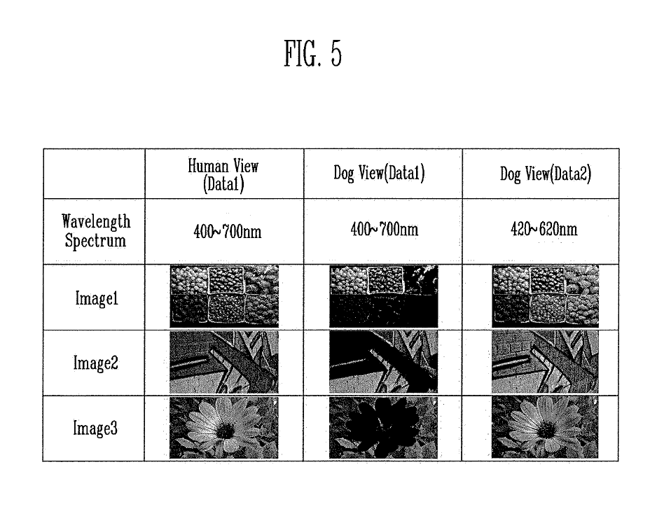

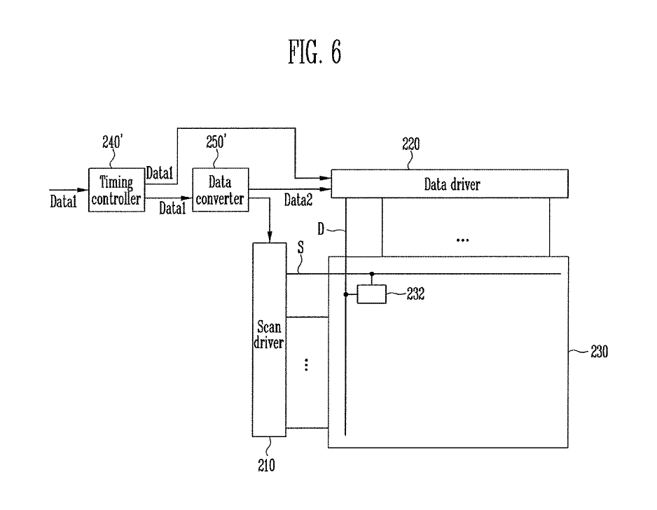

FIG. 5 is a schematic view of images displayed according to the exemplary embodiment.

Referring to FIG. 5, when the first data (Data1) is supplied to the data driver 220, the image of the first wavelength range visible to humans is displayed on the pixel area 230, e.g., images as viewed by humans when the first data (Data1) is displayed on the pixel area 230 are illustrated in the first (left) column of FIG. 5. In this case, pet animals, e.g., dogs, do not correctly recognize the image displayed on the pixel area 230, e.g., images as viewed incorrectly by dogs when the first data (Data1) is displayed on the pixel area 230 are illustrated in the middle column of FIG. 5.

In contrast, according to embodiments, images corresponding to the second wavelength range, which is visible to pet animals, are displayed on the pixel area 230 when the second data (Data2) is supplied. In this case, pet animals may correctly recognize the image displayed on the pixel area 230, e.g., images as viewed correctly by dogs when the second data (Data2) is displayed on the pixel area 230 are illustrated in the last (right) column of FIG. 5. That is, the display device according to embodiments may display the image of the second wavelength range visible to pet animals, and as a result, may arouse interest of pet animals.

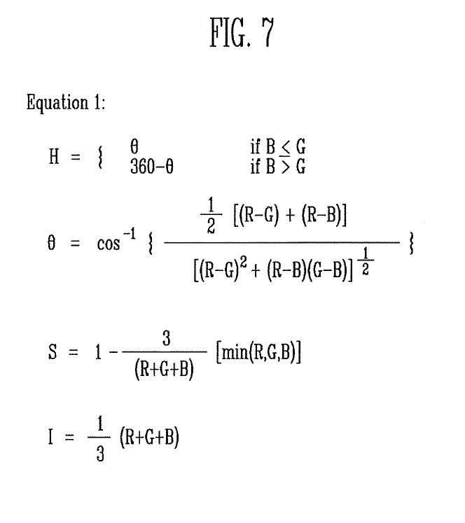

FIG. 6 is a schematic view of a display device according to another exemplary embodiment.

Referring to FIG. 6, a display device according to another exemplary embodiment may include the scan driver 210, the data driver 220, the pixel area 230, a timing controller 240′, and a data converter 250′. In the current exemplary embodiment, the actual operating process is identical to that of the embodiment described previously with reference to FIG. 1, except that the data converter 250 is positioned between the timing controller 240′ and the data driver 220.

The timing controller 240′ receives the first data (Data1) from the outside. After receiving the first data (Data1), the timing controller 240′ supplies the first data (Data1) 1) to the data driver 220 or the data converter 250′ in accordance with a control signal from the outside.

When the first data (Data1) is supplied to the data driver 220, the data driver 220 generates a data signal in accordance with the first data (Data1). The data signal generated from the data driver 220 is supplied to the data lines D, and accordingly, an image corresponding to the first wavelength range is displayed on the pixel area 230.

When the first data (Data1) is supplied to the data converter 250′, the data converter 250′ generates the second data (Data2) by using the first data (Data1). The second data (Data2) generated from the data converter 250′ is supplied to the data driver 220.

When the second data (Data2) is provided to the data driver 220, the data driver 220 generates a data signal by using the second data (Data2). The data signal generated from the data driver 220 is supplied to the data lines D, and accordingly, an image corresponding to the second wavelength range is displayed on the pixel area 230.

The data converters 250 and 250′ according to the exemplary embodiments generate the second data (Data2) by using the first data (Data1), and may be at various positions if necessary. For example, the data converters 250 and 250′ may be positioned inside the timing controllers 240 and 240′.

By way of summation and review, in order to relieve anxiety of pet animals, the number of households keeping their TVs turned on during the day has been increasing. However, since an image displayed on TV has a wavelength range visible only to humans, it is difficult for pet animals to see it, e.g., most dogs may see distorted colors or may not see TV images at all in specific wavelength ranges due to partial color blindness.

Therefore, the display device according to embodiments and the driving method thereof provide first data having a wavelength range visible to humans and second data having a wavelength range visible to pet animals. The second data is generated using the first data supplied from the outside. In addition, the image visible to pet animals can be displayed using the second data.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A display device, comprising:
a scan driver to supply a scan signal to scan lines;
a data converter to receive a first data corresponding to a first wavelength range and to generate a second data corresponding to a second wavelength range by using the first data;
a data driver to generate a data signal to be supplied to data lines by using the first data or the second data; and
pixels in areas defined by the scan and data lines to emit light in accordance with the data signal.

2. The display device as claimed in claim 1, wherein the first wavelength range is a wavelength range visible to humans.

3. The display device as claimed in claim 1, wherein the second wavelength range is a wavelength range visible to animals.

4. The display device as claimed in claim 3, wherein the second wavelength range is a wavelength range visible to dogs.

5. The display device as claimed in claim 1, further comprising a timing controller to receive the first and second data and to supply the first data or the second data to the data driver.

6. The display device as claimed in claim 1, further comprising a timing controller to supply the first data to the data converter or the data driver.

7. The display device as claimed in claim 1, wherein the data converter includes:
a first converter to receive the first data including red, green, and blue data, and to generate third data by using the first data;
a wavelength converter to generate fourth data including only information corresponding to the second wavelength range by using the third data; and
a second converter to generate the second data including red, green, and blue data by using the fourth data.

8. The display device as claimed in claim 7, further comprising a storage unit for providing at least one minimum value and at least one maximum value corresponding to the second wavelength range to the wavelength converter.

9. The display device as claimed in claim 7, wherein the third data and the fourth data have information about hue (H), saturation, and intensity.

10. A driving method of a display device, the method comprising:
receiving first data corresponding to a first wavelength range;
generating second data corresponding to a second wavelength range by using the first data; and
realizing an image by using the first data or the second data.

11. The driving method as claimed in claim 10, wherein the first wavelength range is a wavelength range visible to humans.

12. The driving method as claimed in claim 10, wherein the second wavelength range is a wavelength range visible to animals.

13. The driving method as claimed in claim 12, wherein the second wavelength range is a wavelength range visible to dogs.

14. The driving method as claimed in claim 10, wherein generating the second data includes:
generating third data including information about hue (H), saturation, and intensity by using the first data including red, green, and blue data;
generating fourth data by extracting the second wavelength range from the third data; and
generating the second data including red, green, and blue data by using the fourth data.
